(19) United States
(12) Patent Application Publication
(10) Pub. No.: US 2025/0202162 A1
(43) Pub. Date: Jun. 19, 2025

(54) ELECTRICAL CONNECTOR WITH ROTATIONAL SNAP-FIT AND SWAPPABLE CONTACT RETAINER

(71) Applicant: IDEAL Industries, Inc., Sycamore, IL (US)

(72) Inventors: Adam Laderoute, Pelham, NH (US); Scott Horner, Marlborough, MA (US); Brendan Crawford, Boston, MA (US)

(21) Appl. No.: 18/545,107

(22) Filed: Dec. 19, 2023

(51) Int. Cl. H01R 13/625; H01R 13/10; H01R 13/502; H01R 13/627

(52) U.S. Cl. CPC H01R 13/625; H01R 13/10; H01R 13/502; H01R 13/627

(57) ABSTRACT

A electrical connector may include a receptacle housing and a plug housing. The receptacle housing may include an outer edge, a first protrusion, and a first recess. The plug housing may include an inner edge, a second protrusion shaped to interface with the first recess, and a second recess shaped to receive the first protrusion. The receptacle housing and the plug housing may be configured to rotate relative to each other between an unlocked orientation and a locked orientation. In the locked orientation, the first protrusion interfaces with the second recess to restrict rotational movement of the plug housing relative to the receptacle housing and the second protrusion interfaces with the first recess to restrict lateral movement of the receptacle housing relative to the plug housing.

### TECHNICAL FIELD

This disclosure generally relates to electrical connectors that are capable of securing together via rotational snap-fit.

### BRIEF DESCRIPTION OF THE DRAWINGS

FIG. 1 is a front perspective view of an example receptacle.

FIG. 2 is front view of the receptacle of FIG. 1.

FIG. 3 is a side view of the receptacle of FIG. 1.

FIG. 4 is a front perspective view of an example plug.

FIG. 5 is a front perspective view of a bayonet of the plug of FIG. 4.

FIG. 6 is a front view of the bayonet of FIG. 5.

FIG. 7 is a detail view of a protrusion of the bayonet of FIG. 5.

FIG. 8 is a detail view of a recess of the bayonet of FIG. 5.

FIG. 9 is a top view of a connection between the receptacle of FIG. 1 and the plug of FIG. 4.

FIG. 10 is a perspective view of the connection of FIG. 9.

FIG. 11 is a partially-exploded view of the receptacle of FIG. 1.

FIG. 12 is a front partially-exploded view of the receptacle of FIG. 1.

FIG. 13 is a detail view of a portion of the receptacle of FIG. 1.

FIG. 14 is a front perspective view of an insert of the receptacle of FIG. 1.

FIG. 15 is a rear perspective view of the insert of FIG. 14.

FIG. 16 is a section view of the receptacle of FIG. 1 taken along line 16-16 in FIG. 1.

FIG. 17A is a front perspective view of the receptacle of FIG. 1 in a first state.

FIG. 17B is a front perspective view of the receptacle of FIG. 1 in a second state.

FIG. 17C is a side view of the receptacle of FIG. 1 in the first state.

FIG. 17D is a side view of the receptacle of FIG. 1 in the second state.

FIG. 17E is a section view of the receptacle of FIG. 1 in the first state taken along lines E-E in FIG. 17A.

FIG. 17F is a section view of the receptacle of FIG. 1 in the second state taken along line F-F in FIG. 17B.

FIG. 18 is a front perspective view of an interior portion of the plug of FIG. 4.

FIG. 19 is a partially-exploded view of the interior portion of FIG. 18.

FIG. 20 is a side partially-exploded view of the interior portion of FIG. 18.

FIG. 21 is a perspective view of an insert of the interior portion of FIG. 18.

FIG. 22 is a rear perspective view of the insert of FIG. 21.

FIG. 23 is a section view of the insert of interior portion FIG. 18 taken along line 23-23 in FIG. 18.

FIG. 24A is a front perspective view of the interior portion of FIG. 18 in a first state.

FIG. 24B is a front perspective view of the interior portion of FIG. 18 in a second state.

FIG. 24C is a side view of the interior portion of FIG. 18 in the first state.

FIG. 24D is a side view of the interior portion of FIG. 18 in the second state.

FIG. 24E is a section view of the interior portion of FIG. 18 in the first state taken along lines E-E in FIG. 24A.

FIG. 24F is a section view of the interior portion of FIG. 18 in the second state taken along line F-F in FIG. 24B.

### DETAILED DESCRIPTION

A novel electrical connector according to the present disclosure may enable a substantially fixed connection that maintains the secured connection in high-temperature environments (e.g., up to 105° C.) and under high-pressure conditions (e.g., 2.6 PSI of submersion pressure). In particular, the novel electrical connector may maintain this connection without the use of metal or springs, which improves the longevity of such a connection, as well as reducing the risk of rusting or inadvertent electrical shocks. This novel electrical connector may also make use of a contact retainer that fixes the relevant electrical wires in place with a snap-fit and friction-based fastener that enables different electrical ports to make use of the improved security without sacrificing modularity.

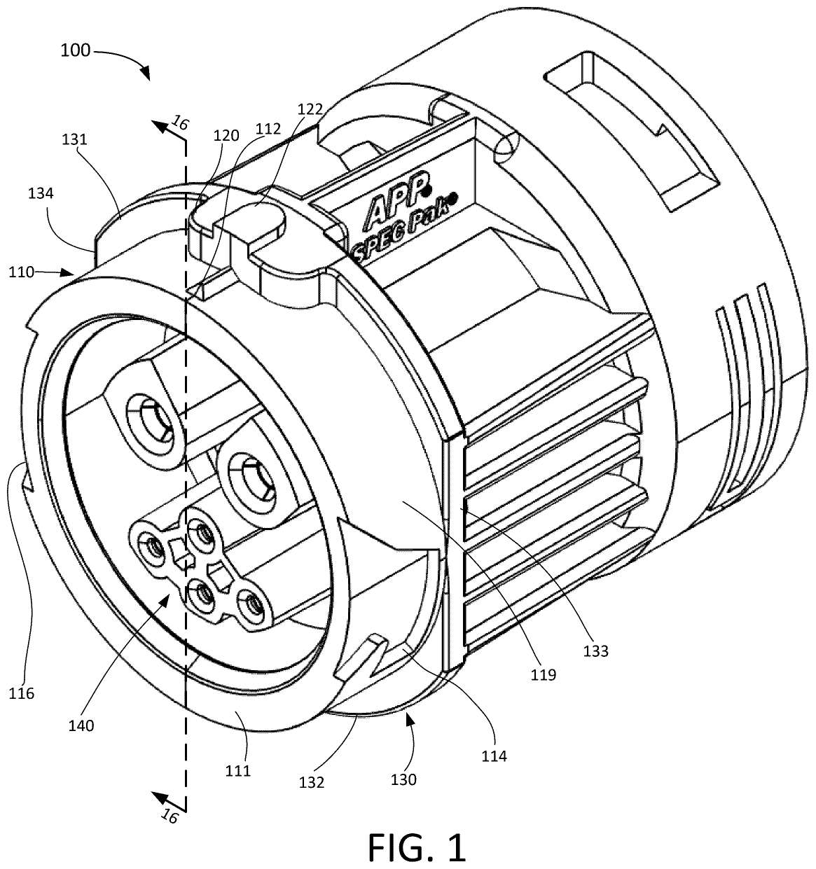

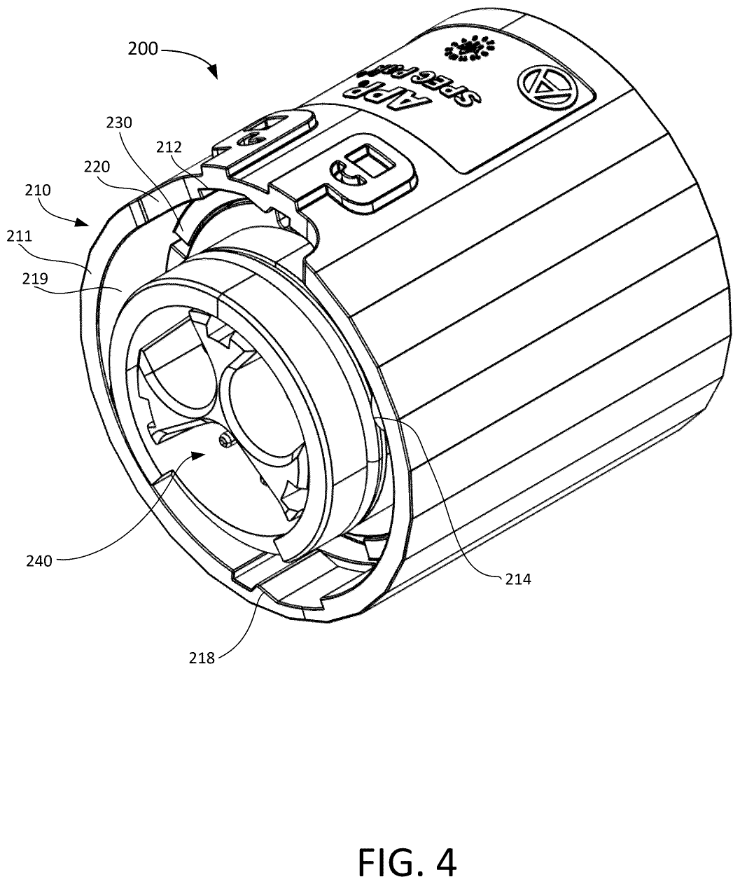

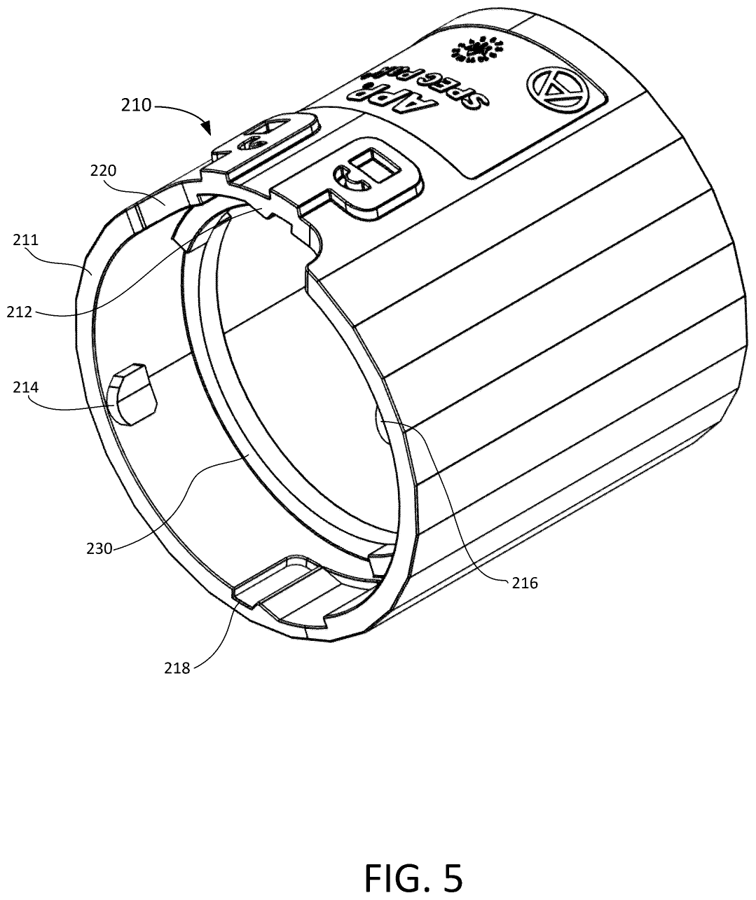

Referring now to the drawings, wherein like numerals refer to the same or similar features in the various views, FIG. 1 illustrates an example receptacle 100. The receptacle 100 may include an insertion portion 110, an orientation block 120, a connection edge 130, and an electrical portion 140. The insertion portion 110 may include one or more components configured to interact with corresponding components on a plug (e.g., plug 200, shown in FIGS. 4-8 and discussed below) in order to facilitate a secure connection. The orientation block 120 may be configured to align the receptacle 100 with a corresponding recess (e.g., orientation recess 220, shown in FIG. 5) of the corresponding plug, and may include an indicator 122 configured to indicate whether the receptacle 100 is in a locked or unlocked state. As shown, the orientation block 120 may extend perpendicularly from the connection edge 130.

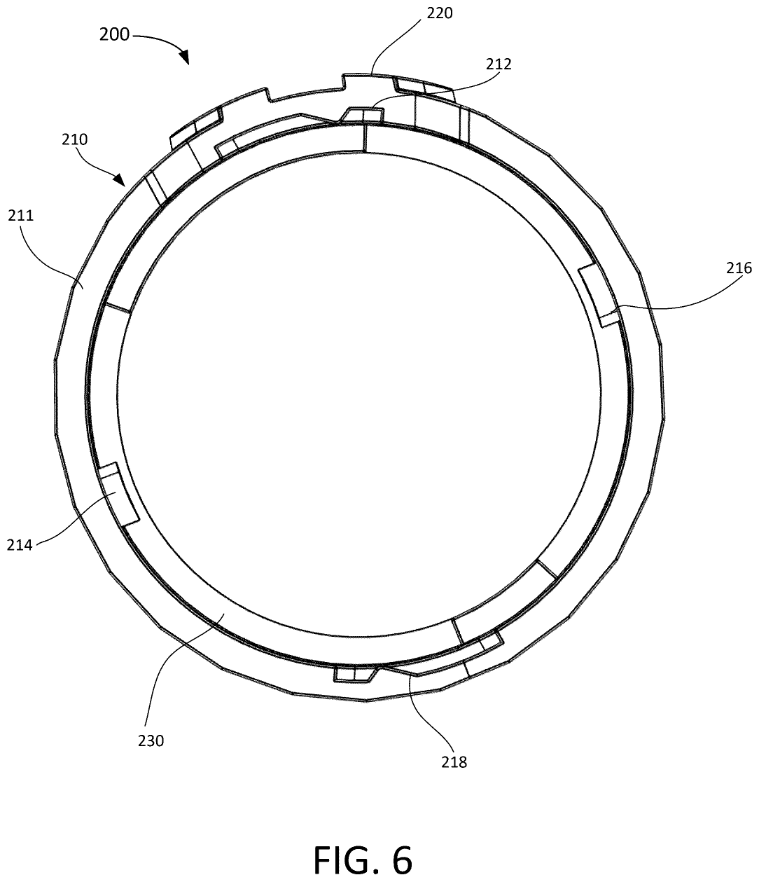

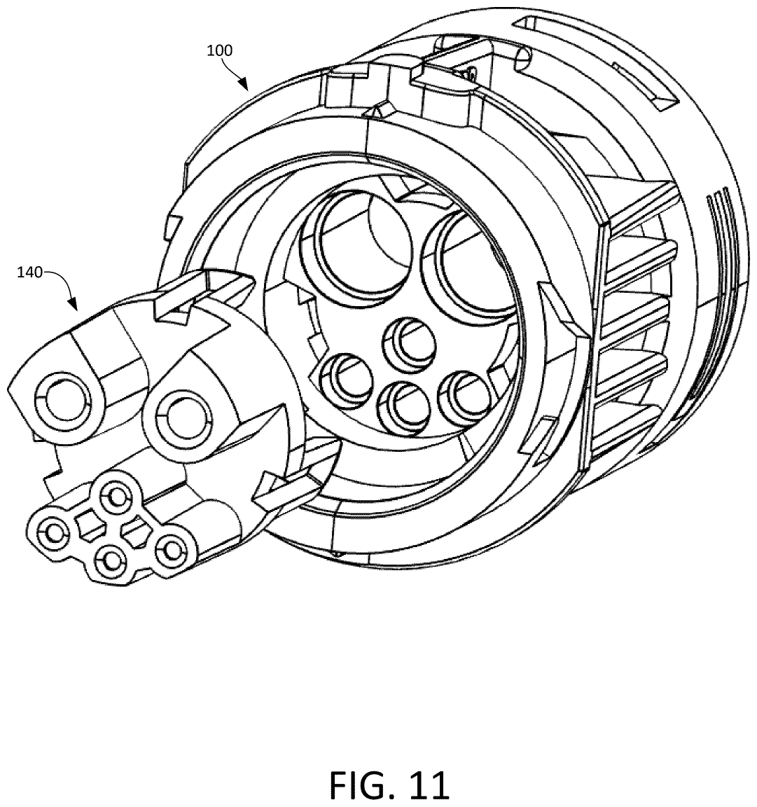

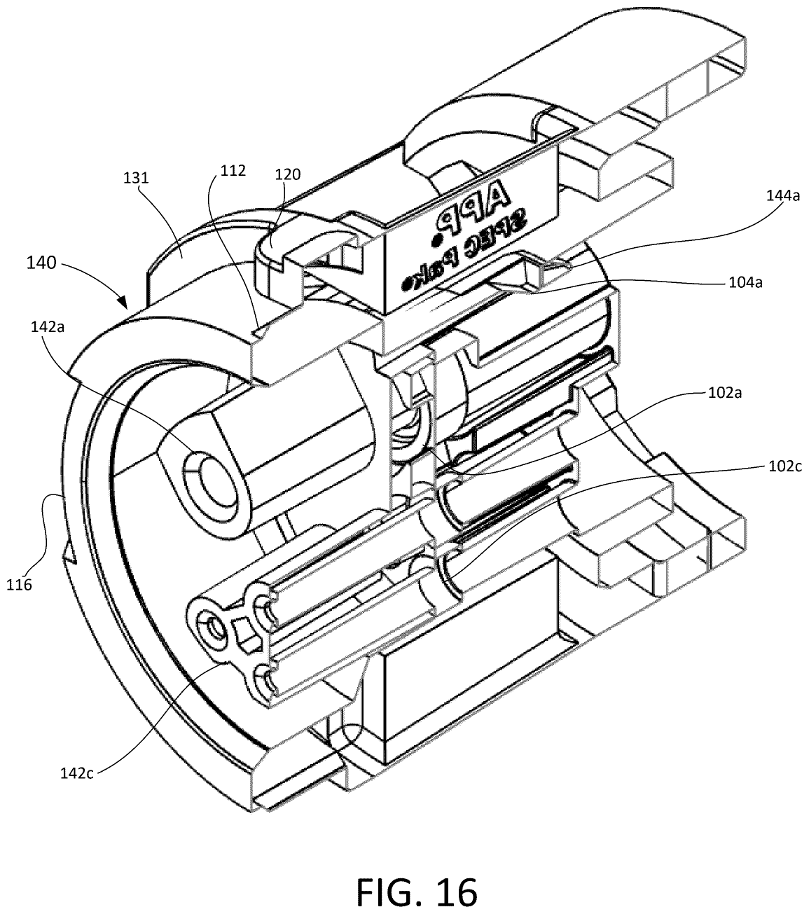

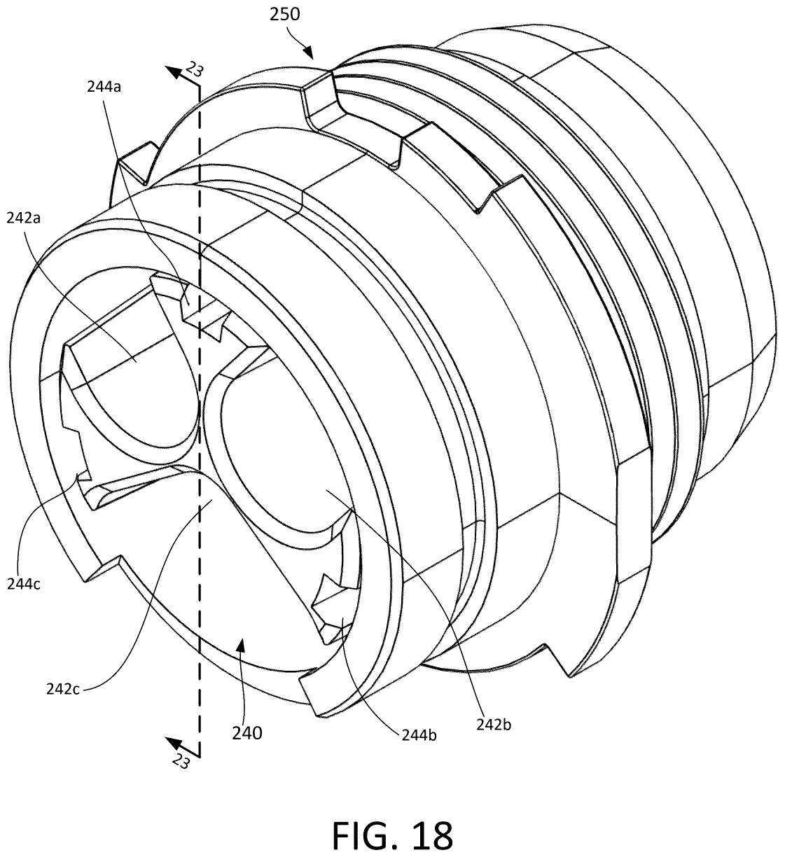

The connection edge 130 may be a portion of the receptacle 100 that is radially larger than the insertion portion 110, such that the connection edge 130 may extend further outwards than the insertion portion 110 relative to a central axis defined by the connection of the receptacle 100 with a plug. Accordingly, the connection edge 130 may limit a length of insertion of the receptacle 100, such that the connection edge 130 abuts a corresponding surface (e.g., a front face of bayonet 210, shown in FIG. 6) of a plug in order to prevent further insertion of the receptacle 100 into the plug. The electrical portion 140 may facilitate an electrical connection between wires connected to the electrical portion 140 (e.g., via the snap-fit connecter described in depth with regard to FIGS. 11-17) to a corresponding electrical portion (e.g., electrical portion 240, shown in FIG. 18) of a corresponding plug.

With reference to FIGS. 1-3, the insertion portion 110 may have an insertion surface 119, which may include four connection-facilitating components: ridges 112 and 118 and slots 114 and 116. The insertion surface 119 may be an outer surface of the insertion portion 110, and may be uniformly arcuate (except for the portions that are cut-out for the slots 114 and 116, as discussed below) due to the insertion portion 110 opening being circular (e.g., having a uniform radius). The insertion surface 119 may have a uniform longitudinal (e.g., relative to the central axis defined by the connection of the receptacle 100 into the plug 200) length defined by a front-most edge 111 and the connection edge 130.

Ridges 112 and 118 may be protrusions that extend radially outward from the insertion surface 119 relative to a center of the receptacle 100, and may be configured to interact with corresponding slots (e.g., slots 212 and 218) of a corresponding plug (e.g., plug 200). As shown, the ridges 112 and 118 may have sloped (or slanted) surfaces on either side of an apex of the ridge 112, 118 to facilitate the interaction with the plug's slots and to enable the apex of the ridge 112, 118 to interface with a corresponding chamber of the plug's slot.

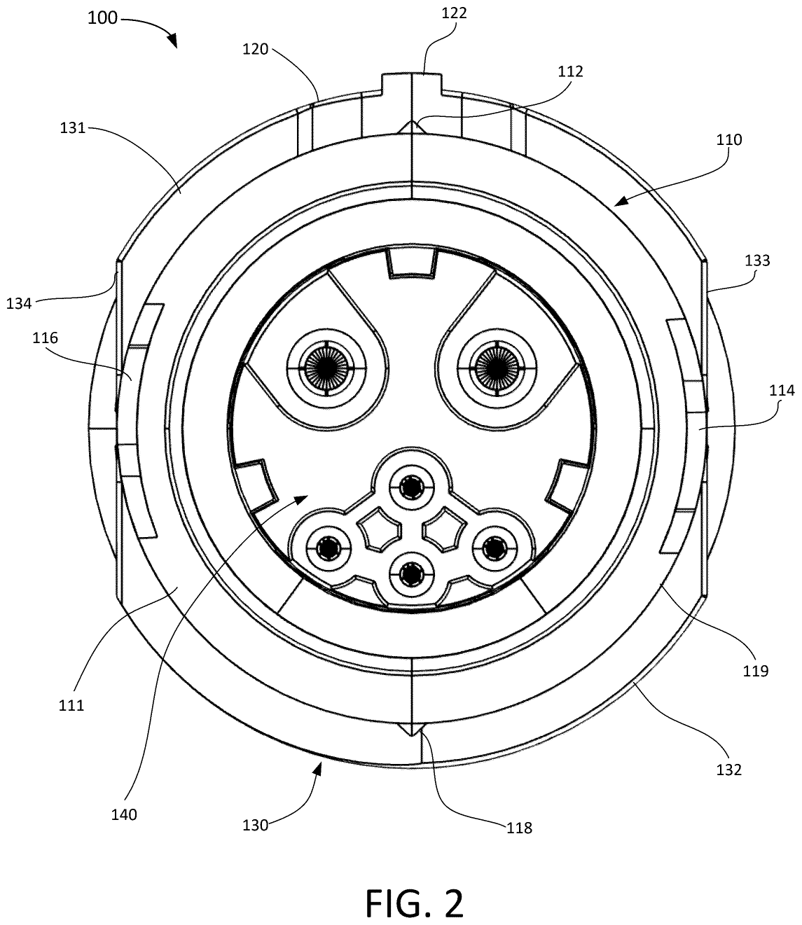

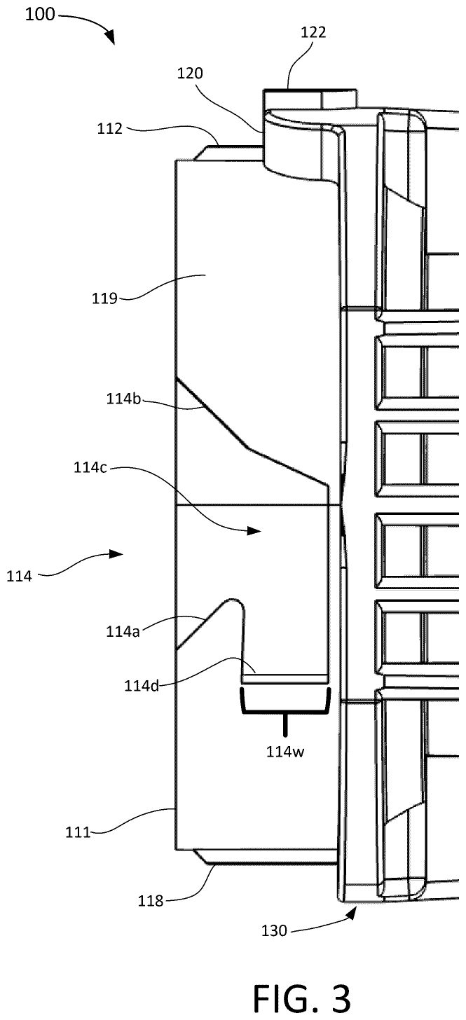

The slots 114, 116 may be formed by the removal of material from the insertion portion 110, such that the upper edges of the slots 114, 116 may be in line with the insertion surface 119. This is shown most clearly in the front view of FIG. 2, which illustrates that the slots 114, 116 may be positioned within (e.g., below, closer to a center of the receptacle 100, etc.) the insertion surface 119. Furthermore, slots 114, 116 may be substantially identical to each other but positioned on radially-opposite sides of the insertion surface 119. Put differently, slot 116 may be a mirrored copy of slot 114, or one that has been rotated 180° about the axis of the insertion portion 110. Accordingly, the portions of the slot 114 shown towards a relative bottom of the slot 114 relative to the views of FIGS. 2-3 may be identical to the portions of the slot 116 shown towards a relative top of the slot 116. In this manner, the slots 114, 116 may be configured to receive corresponding protrusions of the receptacle 200 and facilitate rotation of the receptacle 200 in the same direction (e.g., clockwise relative to FIG. 2), which would cause the protrusion in slot 116 to move relatively upwards and the protrusion in slot 114 to move relatively downwards. Accordingly, the slot 116 may have each of the components of the slot 114 that are described below with reference to FIG. 3.

As indicated in FIG. 3, the slot 114 may include a first slope 114a and a second slope 114b that collectively form a larger (e.g., relative to a width of the corresponding protrusion taken along a circumference of the insertion portion 110) opening to the slot 114 and taper into a chamber 114c. By initially providing the larger opening, the slot 114 may provide a degree of tolerance for a received protrusion (e.g., protrusions 214, 216) that then guide the protrusion to a securing position. Given that the receptacle 100 and plug 200 may be generally configured to mate as concentric circles, the larger opening of the slots 114, 116 allow for the initial (rotational) positioning of the plug 200 relative to the receptacle 100 to have some margin for error.

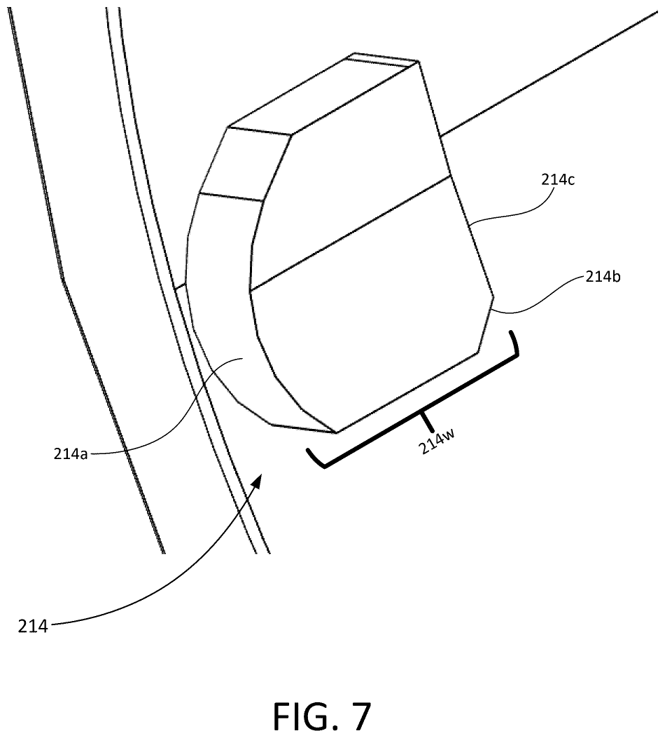

A secure sub-chamber 114d may extend from the chamber 114c along a circumference of the insertion portion 110, and may be configured to be a final position for the received protrusion. Accordingly, the sub-chamber 114d may be sized and shaped to be substantially similar to the dimensions of the received protrusion (as described in greater depth below with regard to FIG. 7). In particular, the sub-chamber 114d may have a length 114W (e.g., measured in the direction defined by the central axis defined by the connection of the receptacle 100 into the plug 200) that may be substantially (e.g., within a degree of tolerance) equal to a width of the corresponding protrusion, such that the protrusion may fit snugly within the sub-chamber 114d. While in the sub-chamber 114d, longitudinal (e.g., along an axis defined by the direction of insertion) movement of the protrusion may be prevented by the walls of the sub-chamber 114d.

With reference again to FIG. 2, the connection edge 130 may include an upper portion 131 and a lower portion 132. As shown, each of the upper portion 131 and the lower portion 132 may substantially match the overall shape of the receptacle 100 with a curvature that follows the concentric circles of the receptacle 100. However, each of the upper portion 131 and the lower portion 132 may sharply transition into flat sides—right side 133 and left side 134—that substantially align with an outermost edge of the insertion portion 110, such that the right side 133 and left side 134 (relative to the front view of FIG. 2) of the connection edge 130 do not extend radially beyond the insertion surface 119. Each of the right side 133 and left side 134 may be configured to improve the ergonomic properties of the receptacle 100.

FIG. 4 illustrates an example plug 200. The plug 200 may include a bayonet 210, an indicator portion 220, and a connector portion 240. FIG. 5 illustrates the bayonet 210 with the connector portion 240 omitted for clarity, which further shows a connection edge 230 within the bayonet 210. The bayonet 210, like the insertion portion 110 of the receptacle 100, may have a reception surface 219, which may include several features that facilitate a secure connection between the receptacle 100 and the plug 200. In particular, the reception surface 219 may include four connection-facilitating components: recesses 212 and 218 (which may mate with and correspond to ridges 112 and 118 of the insertion portion 110) and protrusions 214 and 216 (which may mate with and correspond to slots 114 and 116 of the insertion portion 110). The reception surface 219 may be an inner surface of the bayonet 210, and may be uniformly arcuate (except for the portions that are cut-out for the recesses 212 and 218, as discussed below) due to the bayonet 210 opening being circular (e.g., having a uniform radius). The reception surface 219 may have a uniform longitudinal (e.g., relative to the central axis defined by the connection of the receptacle 100 into the plug 200) length defined by a front-most edge 211 and a connection edge 230. The front-most edge 211 may be configured to abut the connection edge 130 of the receptacle 100 when the receptacle 100 is inserted into the plug 200.

The indicator portion 220 may be a carved-out (e.g., removed, omitted, etc.) portion of the bayonet 210 that may be configured to receive the corresponding indicator block 120 of the receptacle 100. In addition to enabling an interaction between symbols (e.g., the “lock” and “unlock” symbols) on the indicator portion 220 and the indicator 122 of the receptacle 100, the indicator portion 220 may be further configured to guide insertion of the receptacle 100 into the plug 200 via alignment of the indicator block 120 into the indicator portion 220. The connection edge 230 may be configured to abut the front-most edge 111 of the insertion portion 110, such that the connection edge 230 may prevent further movement of the receptacle 100 once inserted into the plug 200.

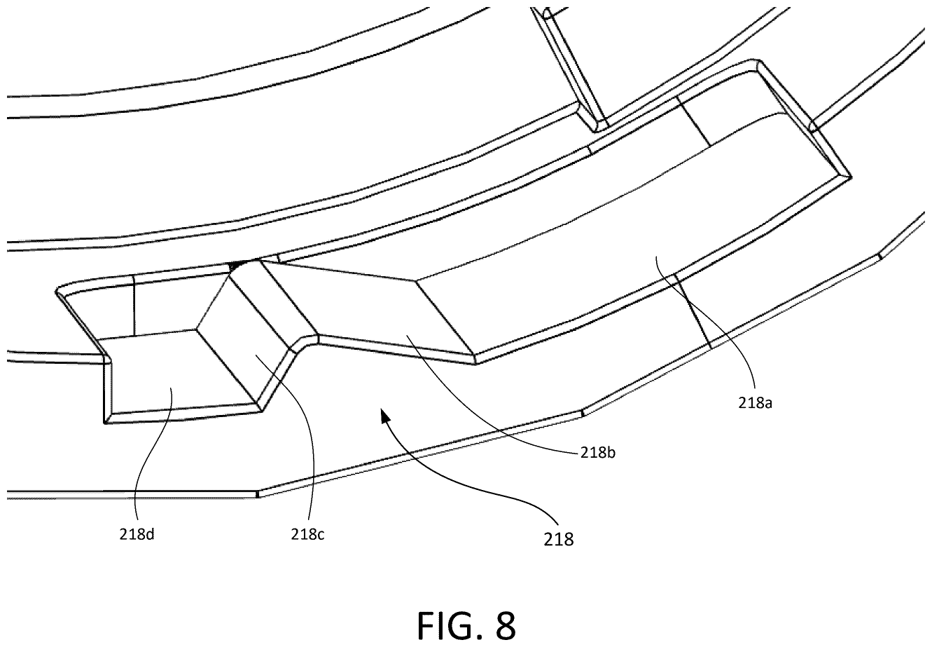

With reference to the front view of FIG. 6, each of the recesses 212 and 218 may be positioned within the bayonet 210, such that the recesses 212, 218 may be formed by the removal of material from the bayonet 210. FIG. 8 is a detailed view of the recess 218, and shows that the recess includes a first length 218a, a first slope 218b, a second slope 218c, and a second length 218d. In action, the first length 218a may receive ridge 118 of the receptacle 100, and may be, therefore, wider relative to a width of the ridge 118 (e.g., as defined along the circumference of the insertion portion 110) in order to accommodate the receptacle 100 being at a number of rotational orientations when inserted (e.g., for the same reason that the slots 114, 116 may have larger openings). When the bayonet 210 is rotated to secure the connection, the ridge 118 may abut the first slope 218b. Because the bayonet 210 may be formed of a semi-rigid material (e.g., plastic), the bayonet 210 may deform slightly while maintaining its overall structure. Here, the bayonet 210 (and particularly the recess 218) may deform slightly as the ridge 118 moves along the first slope 218b, with the bayonet 210 deforming most when the ridge 118 reaches the transition (e.g., apex) from the first slope 218b to the more-drastically sloped second slope 218c.

The shape of the first slope 218b, combined with the shape of the ridge 118, may create tactile feedback for a user with increasing resistance as the ridge 118 proceeds along the first slope 218b. When the ridge 118 crosses the transition, the shape of the second slope 218c may cause the ridge 118 to slide into the second length 218d, which may be significantly shorter than the first length 218a as the second length 218d does not need the higher tolerance of the first length 218a. When the ridge 118 is positioned within the second length 218d, the plug 200 and receptacle 100 are in their secured connection state. Accordingly, an attempt to move the ridge in reverse (e.g., from the second length 218d to the first length 218a) would come from attempting to decouple the plug 200 and receptacle 100. To this end, the shape of the second slope 218c is steeper than that of the first slope 218b, which creates a higher resistance to traverse. As such, the tactile feedback provided by the shape of the recess 218 indicates, to a user, that more force is required to decouple the plug 200 and receptacle 100.

Similarly to the slots 114, 116 of the receptacle 100, the recesses 212 and 218 may be identical to each other but positioned rotationally 180° apart, such that the corresponding ridges 112, 118 may have a substantially identical “path” across the recesses 212, 218 during rotation. Accordingly, although the recess 212 is not the subject of a detailed view, it should be understood that the first length 218a, the first slope 218b, the second slope 218c, and the second length 218d may be present in the recess 212 in substantially-identical shape and positioning.

FIG. 7 is a more detailed view of the ridge 214. As shown, the ridge 214 may include a leading edge 214a, a rear slope 214b, and a rear edge 214c. The leading edge 214a may be curved so as to define a convex surface (as in the embodiment shown), or may be any suitable shape for interfacing with the first slope 114a and second slope 114b of the slot 114. In particular, the leading edge 214a may be shaped in order to facilitate movement of the ridge 214 within the slot and into the secure sub-chamber. Similarly, the rear slope 214b may be shaped to guide the ridge 214 within the chamber 114c, and may be sloped to navigate the corner shaped by the end of the first slope 114a meeting the chamber 114c. The leading edge 214a and rear edge 214c may define a length 214W of the ridge, and the width 214W may be substantially (e.g., within an acceptable tolerance) equal to the length 114W of the corresponding slot 114. Accordingly, when the ridge 214 is positioned within the slot 114 (and particularly within the sub-chamber 114d), longitudinal movement (e.g., in the direction along which the length is measured) is prevented—thereby preventing longitudinal movement (e.g., along the central axis defined by the connection) of the plug 200 and receptacle 100.

Taken as a whole, the interaction between the corresponding components of the insertion portion 110 and the bayonet 210 may restrict movement of the receptacle 100 and plug 200 relative to each other. The ridges 112, 118 may interface with the recesses 212, 218 to inhibit rotational movement of the receptacle 100 and bayonet 210 once the ridges 112, 118 are secured in the recesses 212, 218, as the shape of the recesses 212, 218 encourages rotational movement in a first direction (e.g., a “locking” direction) and discourages rotational movement in a second direction (e.g., an “unlocking” direction). In parallel, the slots 114, 116 may interface with the protrusions 214, 216 to prevent longitudinal movement of the plug 200 relative to the receptacle 100.

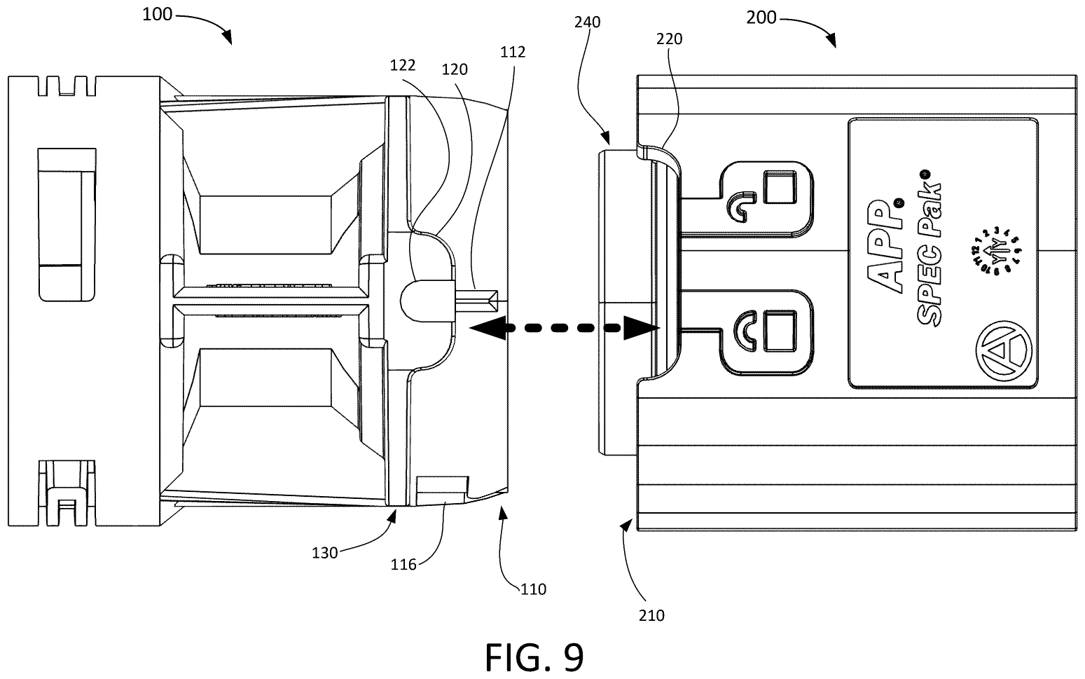

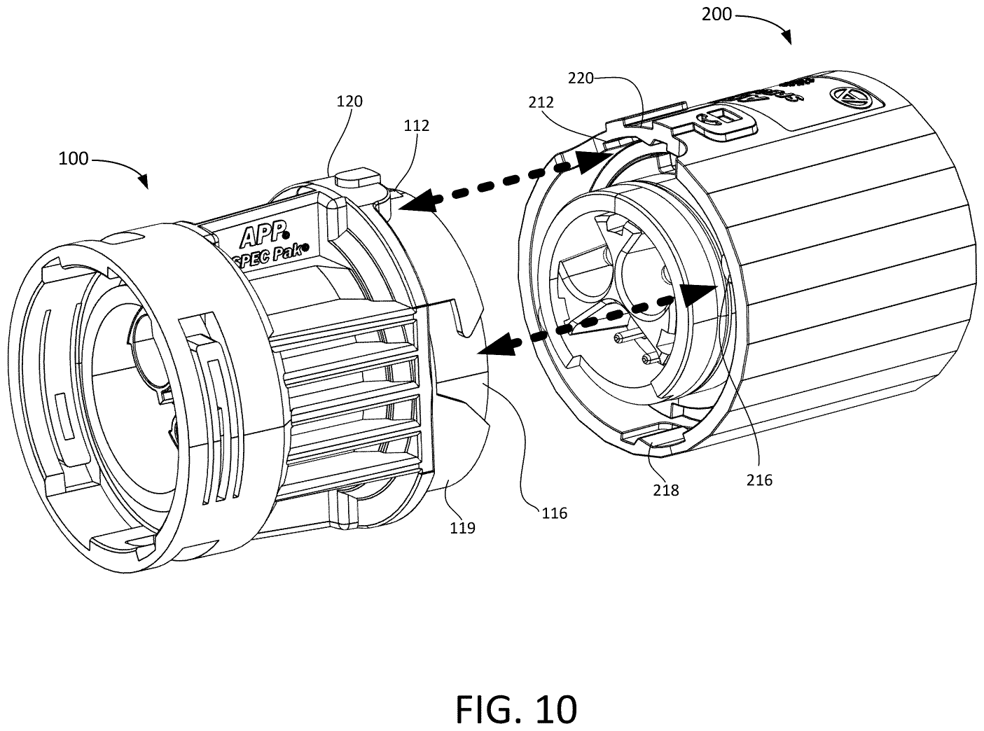

By working together, these components may facilitate two different states for the receptacle 100 and plug 200: an unlocked position and a locked position. In the unlocked position (which may also be an initial position), the ridge 118 may be positioned within the first length 218a and the protrusion 214 may be positioned within the chamber 114c (after the leading edge 214a interacted with the first slope 114a and second slope 114b). This initial positioning is shown in FIGS. 9 and 10, albeit in a state immediately prior to insertion, such that the receptacle 100 and plug 200 are in position to couple but are not yet touching. In transitioning from the unlocked position to the locked position by rotating either the receptacle 100 or the plug 200 in a clockwise direction (e.g., relative to the face of the opposing piece), the ridge 118 may move along the first slope 218b before “snapping” in place into the second length 218d. At the same time, the protrusion 214 may move within the chamber 114c and into the sub-chamber 114d, with the protrusion 214 positioned within the sub-chamber 114d when the ridge 118 is positioned within the second length 218d. Accordingly, longitudinal and rotational movement may be restricted in this positioning, meaning the receptacle 100 and plug 200 may be in the locked position.

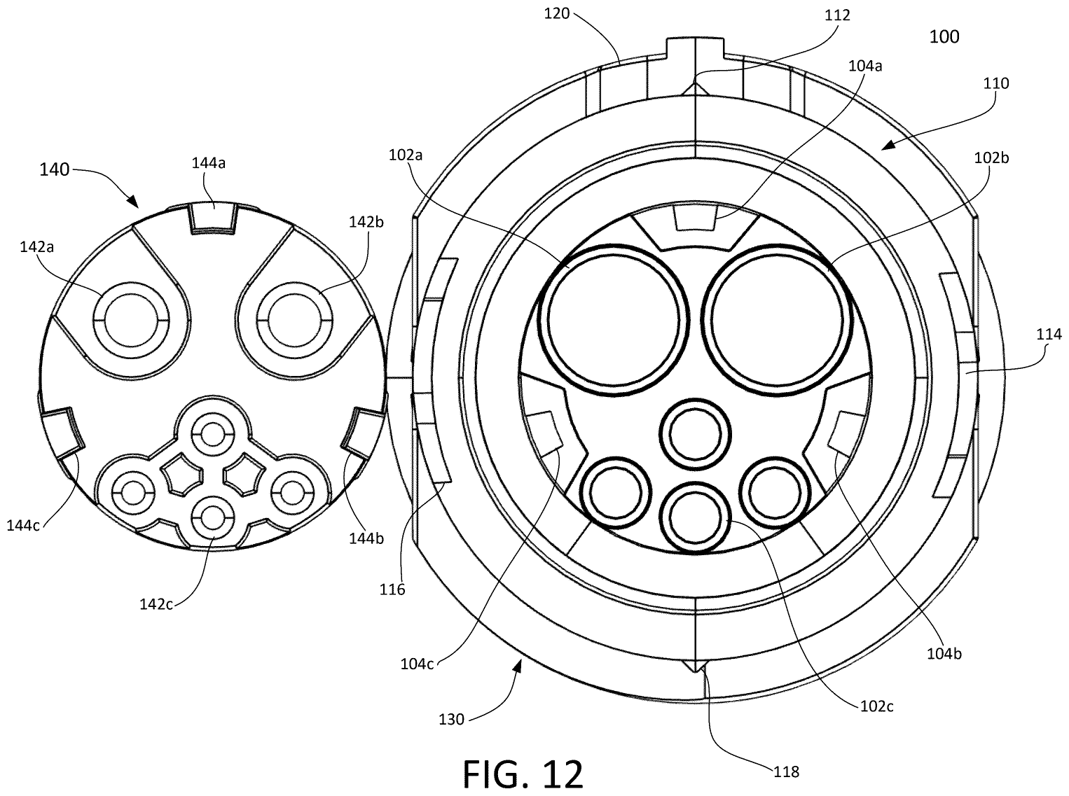

FIGS. 11-16 illustrate how receptacle insert 140 for securing electrical contacts may couple to the receptacle 100 body. The receptacle insert 140 may include a first contact cavity 142a, a second contact cavity 142b, and a third contact cavity 142c (collectively “contact cavities 142”) (see FIGS. 12, 14, and 15). The contact cavities 142 may each be configured to receive a live wire (e.g., exposed end of a wire) to be held in place for forming an electrical connection when the receptacle 100 (and therefore, the receptacle insert 140) is mated with a corresponding plug (e.g., plug 200). Although the contact cavities 142 are shown in a particular arrangement for a particular type of electrical connector, it should be understood that this disclosure should be read to include any arrangement of suitable contact ends for any relevant electrical connector.

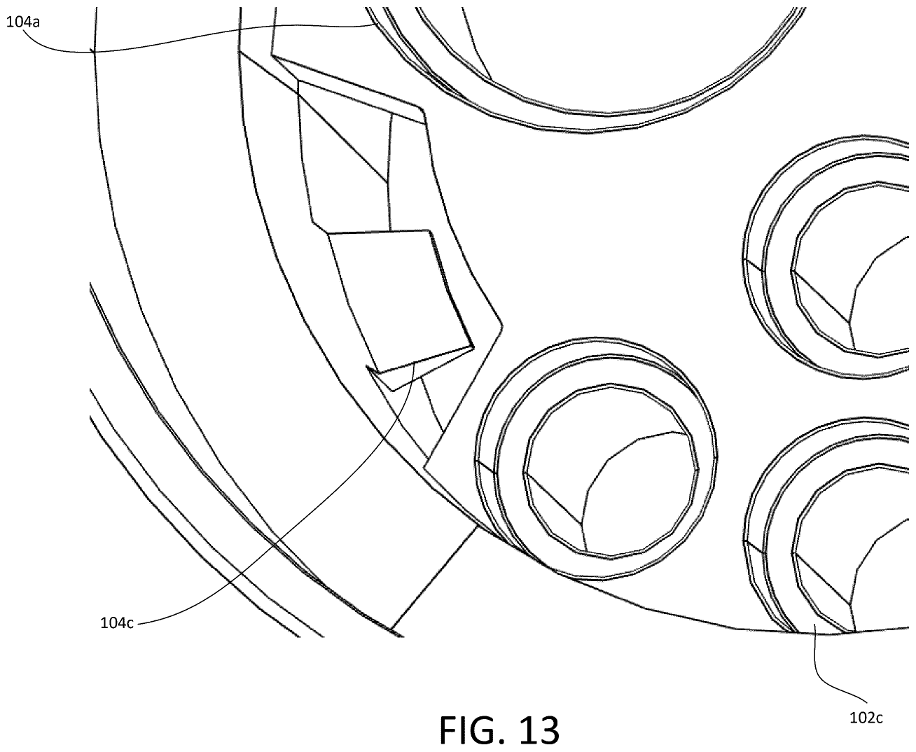

The receptacle insert 140 may further include a first clip 144a, a second clip 144b, and a third clip 144c (collectively “clips 144”) (see FIGS. 12, 14, and 15) that may extend longitudinally away from a front face of the receptacle insert 140. Each clip 144 may align with a corresponding protrusion of the receptacle 100—in particular, a first protrusion 104a may align with the first clip 144a, a second protrusion 104b may align with the second clip 144b, and a third protrusion 104c may align with the third clip 144c (collectively “protrusions 104”) (see FIGS. 12 and 13). Each protrusion 104 may extend radially inward from an interior wall of the receptacle 100, and may be positioned within a larger channel for guiding the corresponding clip 144.

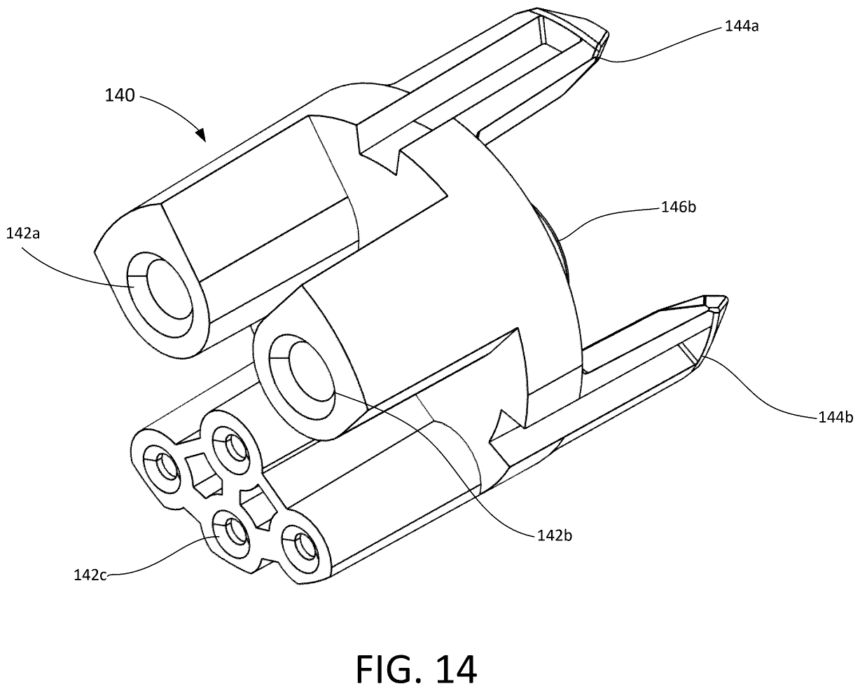

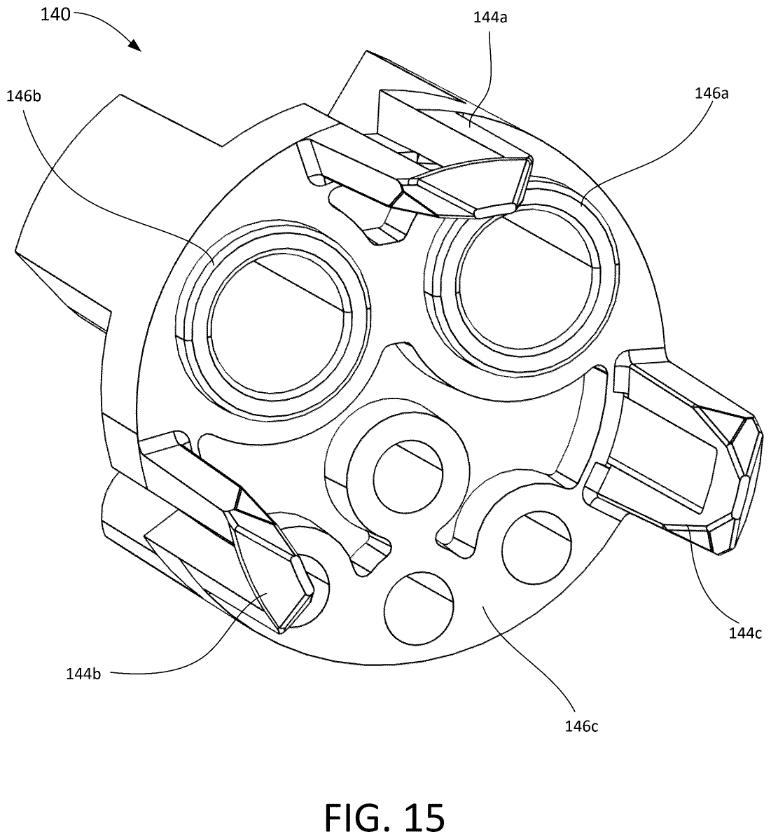

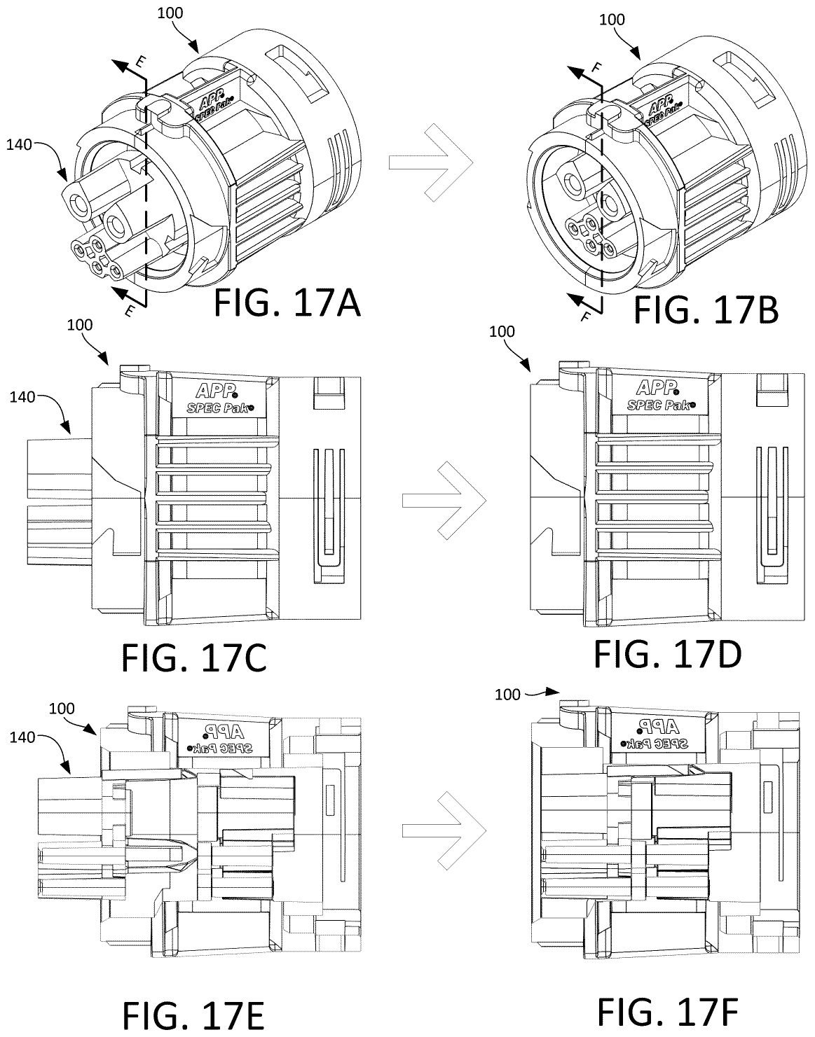

As shown in FIGS. 14 and 15, the clips 144 may be substantially axially U-shaped, with two parallel bars extending axially from the face of the receptacle insert 140 and meeting at a longitudinal end. The end of each clip 144 may have a slanted face in order to facilitate the interaction with a similarly-slanted face of the corresponding protrusion 104, with the interior channel of the clip 144 sized to receive the corresponding protrusion 104. In practice, and with reference to FIGS. 17A-17F, when the receptacle insert 140 is inserted into the receptacle 100, the slanted faces of the clip 144 and its corresponding protrusion 104 cause the clip 144 to flex inward (e.g., towards a center of the receptacle 100) until the protrusion 104 reaches the channel in the center of the clip 144. The protrusion 104 may then slot into the channel of the clip 144, removing the flexing force from the clip 144 and causing the clip 144 to return to an unflexed position substantially-flush with the interior wall of the receptacle 100. When in this position, the un-slanted and opposing side of the protrusion 144 abuts an un-slanted interior wall of the channel, such that the receptacle insert 140 is prevented from moving rotationally or laterally away from the receptacle 100 body.

Referring now to FIG. 15, the receptacle insert 140 may further include a first cavity seal 146a, a second cavity seal 146b, and a third cavity seal 146c (collectively “cavity seals 146”). Each cavity seal 146 may be positioned about an interior opening of a corresponding contact cavity 142, and may be configured to seal the exposed wire within the contact cavity 142. The cavity seals 146 may be formed of a semi-rigid and insulating material (e.g., rubber) that may compress against the interior face of the receptacle 100 body when the receptacle insert 140 is inserted into the receptacle 100.

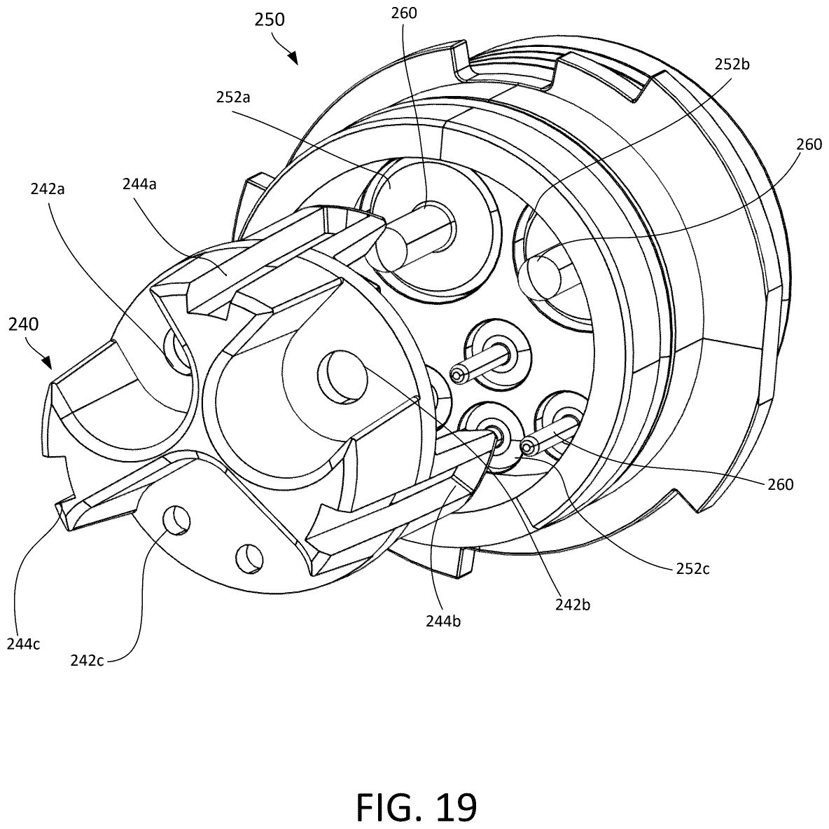

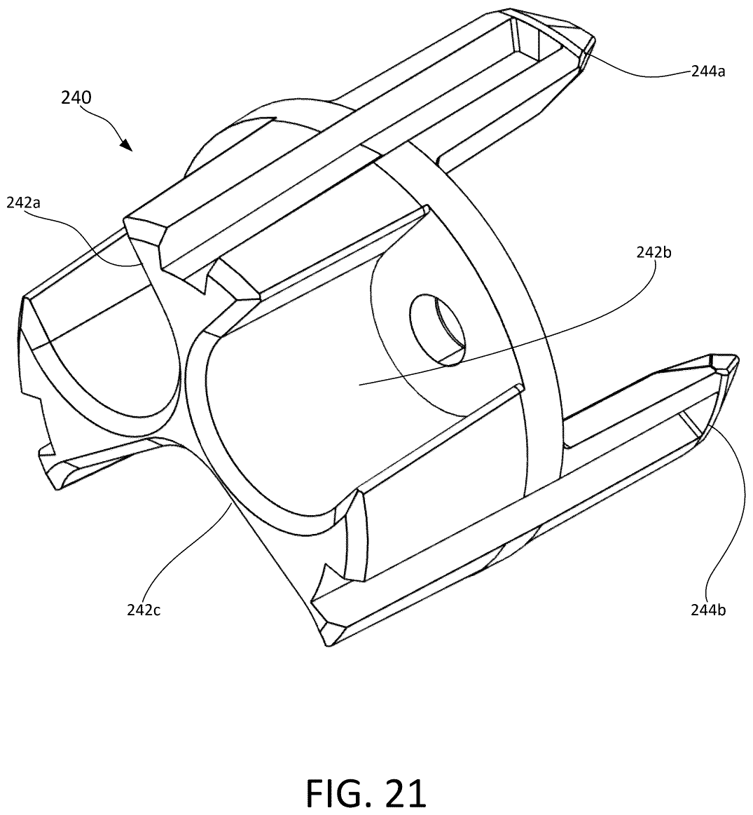

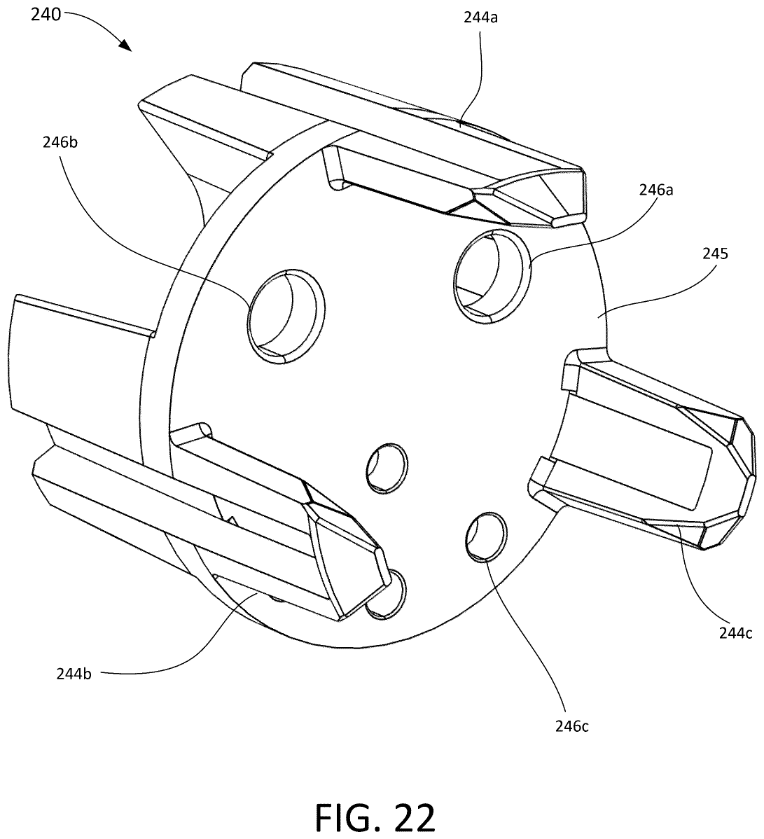

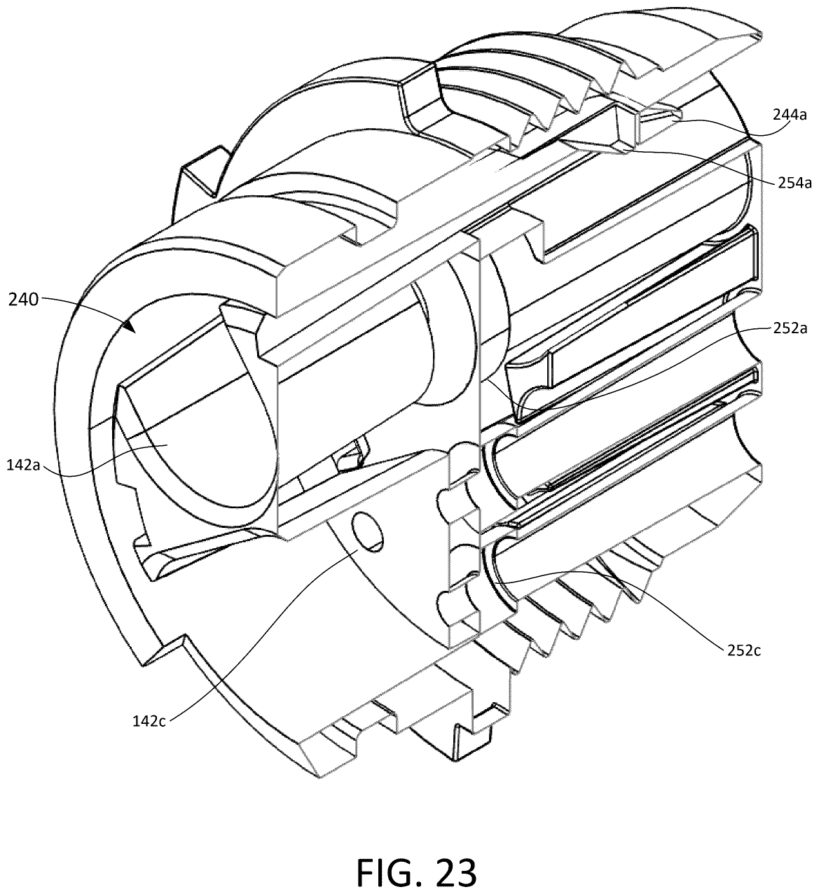

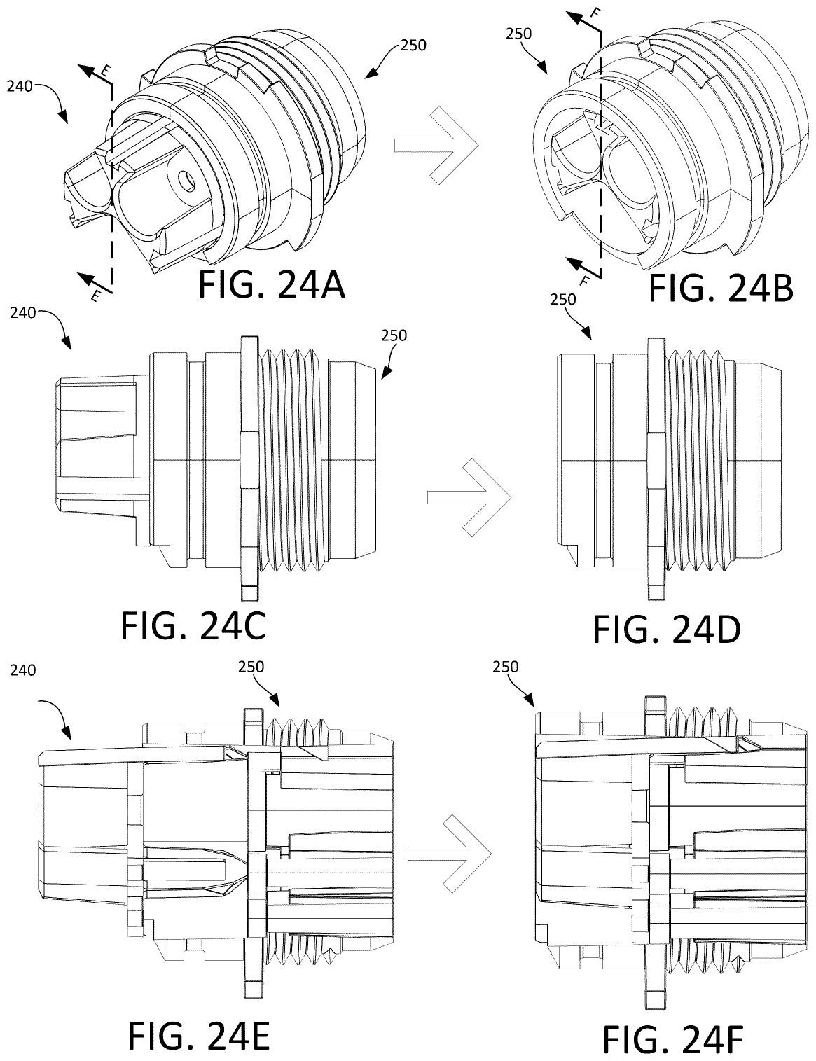

FIGS. 18-23 illustrate how the plug interior portion 250 for securing electrical contacts may form the plug 200 when positioned within the bayonet 210. Similar to the receptacle 100, the interior portion 250 may include a plug insert 240 that may snap-fit within the interior portion 250 in order to hold exposed ends 260 of wires in place for forming an electrical connection across the receptacle 100 and plug 200. These exposed ends 260 are shown in FIG. 19, which is a partially exploded view of the plug insert 240 being removed from the interior portion 250.

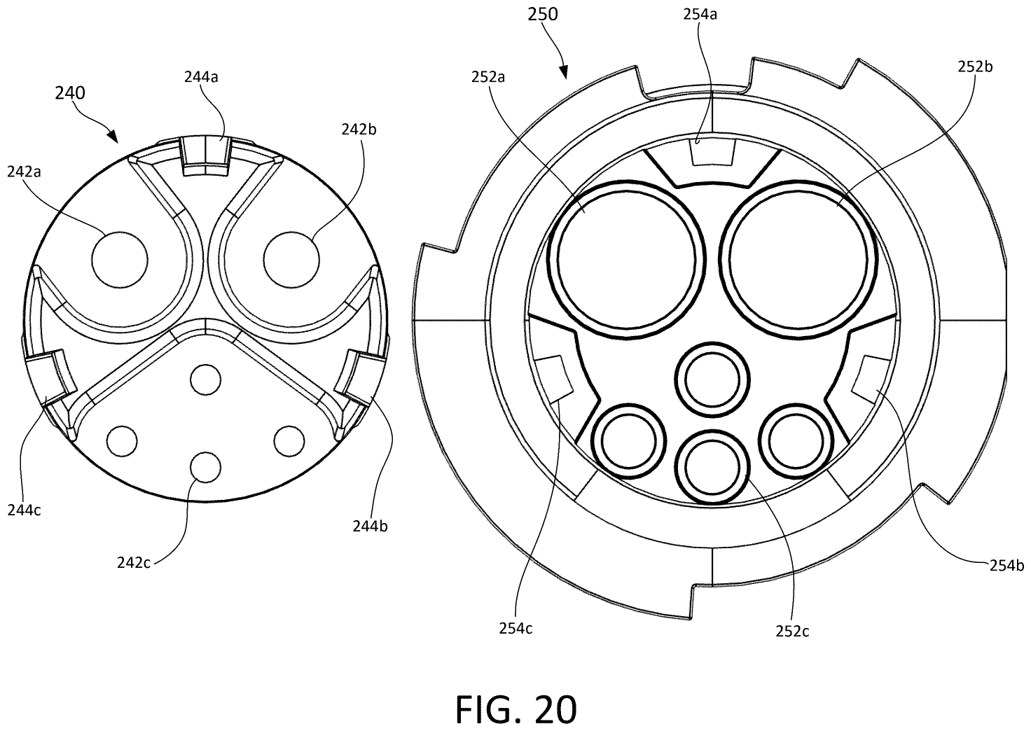

As shown in FIG. 20, the plug insert 240 may include a first contact cavity 242a, a second contact cavity 242b, and a third contact cavity 242c (collectively “contact cavities 242”). The contact cavities 242 may each be configured to receive a live wire (e.g., exposed end of a wire) to be held in place for forming an electrical connection when the plug 200 (and therefore, the plug insert 240) is mated with a corresponding receptacle (e.g., receptacle 100). Although the contact cavities 242 are shown in a particular arrangement for a particular type of electrical connector, it should be understood that this disclosure should be read to include any arrangement of suitable contact ends for any relevant electrical connector.

The plug insert 240 may further include a first clip 244a, a second clip 244b, and a third clip 244c (collectively “clips 244”) that may extend longitudinally away from a front face of the plug insert 240. Each clip 244 may align with a corresponding protrusion of the interior portion 250—in particular, a first protrusion 254a may align with the first clip 244a, a second protrusion 254b may align with the second clip 244b, and a third protrusion 254c may align with the third clip 244c (collectively “protrusions 254”). Each protrusion 254 may extend axially inward from an interior wall of the interior portion 250, and may be positioned within a larger channel for guiding the corresponding clip 244. These clips 244 and protrusions 254 may be shaped and structured similarly to clips 144 and protrusions 104 of the receptacle 100. As such, the functionality described above for the receptacle insert 140 should be understood to apply equally to the plug insert 240.

While this disclosure has described certain embodiments, it will be understood that the claims are not intended to be limited to these embodiments except as explicitly recited in the claims. On the contrary, the instant disclosure may be intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What may be claimed is:

1. A electrical connector comprising:
a receptacle housing comprising:
a substantially-circular outer edge;
a first protrusion positioned on the outer edge and extending radially outward; and
a first recess positioned on the outer edge and extending radially inward;
a plug housing comprising:
a substantially-circular inner edge;
a second protrusion positioned on the inner edge and extending radially inward, the second protrusion shaped to interface with the first recess; and
a second recess positioned on the outer edge and extending radially outward, the second recess shaped to receive the first protrusion,
wherein:
the receptacle housing and the plug housing are configured to rotate relative to each other between an unlocked orientation and a locked orientation,
in the unlocked orientation, the outer edge of the receptacle housing abuts the inner edge of the plug housing, and
in the locked orientation, the first protrusion interfaces with the second recess to restrict rotational movement of the plug housing relative to the receptacle housing and the second protrusion interfaces with the first recess to restrict lateral movement of the receptacle housing relative to the plug housing.

2. The electrical connector of claim 1, wherein:
the first recess comprises a first portion and a second portion,
the second protrusion is positioned in the first portion of the first recess in the unlocked orientation and in the second portion of the first recess in the locked position, and
the second portion of the first recess is shaped for a snug fit with the second protrusion.

3. The electrical connector of claim 2, wherein the second protrusion comprises a curved leading edge configured to interface with slanted walls defining an opening to the first recess in order to guide the second protrusion into the first portion of the first recess in the unlocked orientation.

4. The electrical connector of claim 1, wherein:
the second recess comprises a first slope and a second slope, the second slope steeper than the first slope,
the first protrusion traverses the first slope during a transition from the unlocked orientation to the locked orientation, and
the first protrusion traverses the second slope during a transition from the locked orientation to the unlocked orientation.

5. The electrical connector of claim 4, wherein the plug housing comprises a semi-rigid material capable of flexibly deforming due to the interaction between the first protrusion and the first and second slopes.

6. The electrical connector of claim 1, further comprising:
a receptacle contact positioned within the receptacle housing; and
a plug contact positioned within the plug housing,
wherein the receptacle contact and plug contact are configured to form an electrical connection when the receptacle housing is inserted into the plug housing.

7. The electrical connector of claim 6, wherein the receptacle contact is configured to couple to the receptacle housing via a snap-fit and to secure one or more live contacts to the receptacle contact due to pressure from the snap-fit.

8. An electrical connector comprising:
a connector housing defining an interior surface;
a protrusion extending radially inwards from the interior surface;
a live wire positioned within the connector housing; and
a connector insert comprising:
a contact face having a contact portion configured to receive the live wire; and
a clip portion configured to interact with the protrusion to secure the connector insert within the connector housing,
wherein the interaction between the clip portion and the protrusion seals the live wire within the contact portion.

9. The electrical connector of claim 8, wherein the connector housing is a receptacle housing configured to mate with a bayonet, the receptacle housing further comprising:
an outer surface;
a receptacle protrusion extending radially outward from the outer surface, the receptacle protrusion configured to interface with a corresponding bayonet recess to restrict rotational movement of the bayonet; and
a receptacle recess extending radially inward from the outer surface, the receptacle recess configured to interface with a corresponding bayonet protrusion to restrict lateral movement of the bayonet.

10. The electrical connector of claim 8, further comprising an interior face within the interior surface, the interior face comprising:
an interior hole configured to receive the live wire into the connector housing; and
an interior channel shaped to receive the clip portion, the protrusion positioned within the interior channel.

11. The electrical connector of claim 10, wherein the interaction between the clip portion and the protrusion seals the live wire into the contact portion by compressing the insert against the interior face.

12. The electrical connector of claim 8, wherein:
the clip portion comprises at least three clips,
the protrusion comprises at least three protrusions, and
each of the at least three clips correspond to one of the at least three protrusions.

13. A method for securing a receptacle into a plug, the method comprising:
providing a receptacle housing for the receptacle, the receptacle housing comprising:
an interior surface and an exterior surface;
a receptacle protrusion extending radially outward from the exterior surface; and
a receptacle slot extending circumferentially about a length of the exterior surface;
positioning a live contact in the receptacle housing;
securing a receptacle insert configured to secure a live contact within the receptacle housing, the receptacle insert structured to seal the live contact within the receptacle insert;
providing a bayonet about the plug, the bayonet comprising:
a bayonet protrusion configured to interface with the receptacle slot; and
a bayonet slot configured to receive the receptacle protrusion;
inserting the receptacle into the plug, such that the receptacle insert mates with a corresponding plug contact; and
rotating the bayonet about the receptacle into a locked position,
wherein in the locked position, the receptacle protrusion interfaces with the bayonet slot to restrict rotational movement of the bayonet and the bayonet protrusion interfaces with the receptacle slot to restrict lateral movement of the receptacle relative to the plug.

14. The method of claim 13, wherein the receptacle further comprises an interior face configured to receive the live contact from an external wire into the receptacle housing, and wherein the inserting of the receptacle insert compresses the receptacle insert against the interior face to seal the live contact into the receptacle insert.

15. The method of claim 13, wherein the inserting of the receptacle insert comprises snap-fitting a clip of the receptacle insert to an internal protrusion within the receptacle housing.
